(19) United States
(12) Patent Application Publication
(10) Pub. No.: US 2026/0071911 A1
(43) Pub. Date: Mar. 12, 2026

(54) Power-Aware DFOS Placement Strategy for Resilient Infrastructure Monitoring

(71) Applicant: NEC Laboratories America, Inc., Princeton, NJ (US)

(72) Inventors: Yangmin Ding, East Brunswick, NJ (US); Andrea D'Amico, Plainsboro Township, NJ (US); Yue Tian, Princeton, NJ (US); Ting Wang, West Windsor, NJ (US); Md Zahidul Islam, Bayonne, NJ (US)

(73) Assignee: NEC Laboratories America, Inc., Princeton, NJ (US)

(21) Appl. No.: 19/324,098

(22) Filed: Sep. 9, 2025

Related U.S. Application Data
(60) Provisional application No. 63/692,738, filed on Sep. 10, 2024.
(60) Provisional application No. 63/708,415, filed on Oct. 17, 2024.

(51) Int. Cl. G01H 9/00; G01D 5/353

(52) U.S. Cl. CPC G01H 9/004; G01D 5/35358

(57) ABSTRACT

Disclosed is a distributed acoustic sensing (DAS) placement method that explicitly accounts for power supply limitations. By strategically positioning DAS devices within a network in a manner that optimizes power availability and minimizes risk of monitoring blind spots during power outages, our method enhances overall resilience of a DAS monitoring system. Our method combines a heuristic algorithm, PURE (Power Source-aware Route Exploration), with Integer Linear Programming (ILP) optimization. The PURE algorithm explores all possible fiber routes that satisfy both fiber-side constraints-such as linear, non-branching routes within the operational range and power-side constraints, ensuring that DFOS devices are powered independently. The ILP then selects the optimal set of DFOS units to minimize the total number of sensors while meeting monitoring requirements. Our method ensures continuous monitoring even under adverse conditions and reduces costs associated with DAS deployment by eliminating a need for extensive new infrastructure or redundant systems.

### CROSS REFERENCE TO RELATED APPLICATIONS

This application claims the benefit of U.S. Provisional Patent Application Ser. No. 63/692,738 filed Sep. 10, 2024, and U.S. Provisional Patent Application Ser. No. 63/708,415 filed Oct. 17, 2024. the entire contents of each of which is incorporated by reference as if set forth at length herein.

### FIELD OF THE INVENTION

This application relates generally to distributed fiber optic sensing (DFOS)/distributed acoustic sensing (DAS). More particularly it pertains to a power-aware DFOS placement strategy for infrastructure monitoring and the optimal placement of distributed acoustic sensing (DAS) devices in configurations where the electric power supply is a limiting factor.

### BACKGROUND OF THE INVENTION

Distributed acoustic sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting the environment as well as infrastructure.

Traditional approaches to deploying DAS and similar Distributed Fiber Optic Sensing (DFOS) technologies often assume that the power supply for these devices is stable and reliable. However, in real-world scenarios, particularly in the context of increasingly frequent power disruptions caused by extreme weather events, natural disasters, and cyberattacks, this assumption is often invalid. When power failures occur, DAS devices can lose their functionality, rendering large portions of the monitored network unobservable. This presents a significant risk to the integrity and safety of critical infrastructure systems.

Moreover, existing guidelines and strategies for DAS placement do not adequately consider the impact of power supply constraints on system resilience. This gap in the current state of the art leaves critical infrastructures vulnerable to monitoring failures during power outages, potentially leading to delayed response times and exacerbating the effects of any disruptions

### SUMMARY OF THE INVENTION

The above problem is solved and an advance in the art is made according to aspects of the present disclosure directed to a novel DAS placement method that explicitly accounts for power supply limitations. In sharp contrast to the prior art, our inventive method integrates power supply constraints into DFOS placement strategies.

By strategically positioning DAS devices within a network in a manner that optimizes power availability and minimizes risk of monitoring blind spots during power outages, our inventive method enhances overall resilience of a DAS monitoring system. Advantageously, our inventive method not only ensures continuous monitoring even under adverse conditions but also reduces the costs associated with DAS deployment by avoiding the need for extensive new infrastructure or redundant systems

DFOS/DAS systems, methods, and structures that advantageously—and in sharp contrast to the prior art—enhances rainfall sensing by introducing a Deep Phase-Magnitude Network (DFMN), dividing raw DFOS sensing data into phase and magnitude components, and performing targeted feature learning on each component independently.

In further contrast to the prior art, our inventive systems, methods, and structures employ a Phase Frequency learnable filter (PFLF) for phase component filtering and utilize standard convolution layers on the magnitude component, advantageously leveraging inherent physical properties of optical fiber sensing. Finally, a phase-magnitude channel is formulated in a parallel network and subsequently fuses the features for a comprehensive analysis. Experimental results on collected fiber sensing data show that our method according to aspects of the present disclosure performs favorably as compared with alternative, state-of-the-art approaches.

### BRIEF DESCRIPTION OF THE DRAWING

FIG. 1(A) and FIG. 1(B) are schematic diagrams showing an illustrative prior art uncoded and coded DFOS systems.

FIG. 2(A) and FIG. 2(B) show example DAS placement strategy for monitoring an electric network in which: FIG. 2.(A) shows full coverage during normal conditions; and FIG. 2(B) shows reduced coverage during failure conditions according to aspects of the present disclosure.

FIG. 3(A) and FIG. 3(B) show example DAS placement strategy for resilient system monitoring for an electric network in which: FIG. 2.(A) shows full coverage during normal conditions; and FIG. 2(B) shows continuous coverage during DAS device failure conditions according to aspects of the present disclosure.

FIG. 4 shows a real-world 240 node distribution network located in Midwest U.S. according to aspects of the present invention.

FIG. 5 shows a flow-chart of an illustrative heuristic method for finding DAS location and coverage routes according to aspects of the present disclosure.

FIG. 6 shows an illustrative feature diagram in a hierarchical format according to aspects of the present invention.

FIG. 7(A) and FIG. 7(B) show DFOS sensing routes in which: FIG. 7(A) is a power source unaware DFOS sensing route; and FIG. 7(B) is a power source aware DFOS sensing route according to aspects of the present disclosure.

FIG. 8 is a schematic block diagram showing illustrative methodology according to the present disclosure and a breakout of the PURE algorithm employed according to aspects of the present disclosure.

FIG. 9(A) and FIG. 9(B) show power infrastructure monitoring in which: FIG. 9(A) shows a network used for experiment: IEEE standard 33-node network; and FIG. 9(B) coverage comparison between proposed (PM) and baseline (BM) methods durin a feeder zone outage, averaged over 100 runs; according to aspects of the present disclosure.

FIG. 10(A) and FIG. 10(B) show telecommunications network monitoring monitoring in which: FIG. 10(A) shows a network used for experiment: a real network in Atlanta, GA; and FIG. 10(B) coverage comparison between proposed (PM) and baseline (BM) methods durin a feeder zone outage, averaged over 100 runs; according to aspects of the present disclosure.

FIG. 11 is a schematic block diagram of an illustrative computer system in which methods or components of methods according to the present disclosure may be loaded/executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

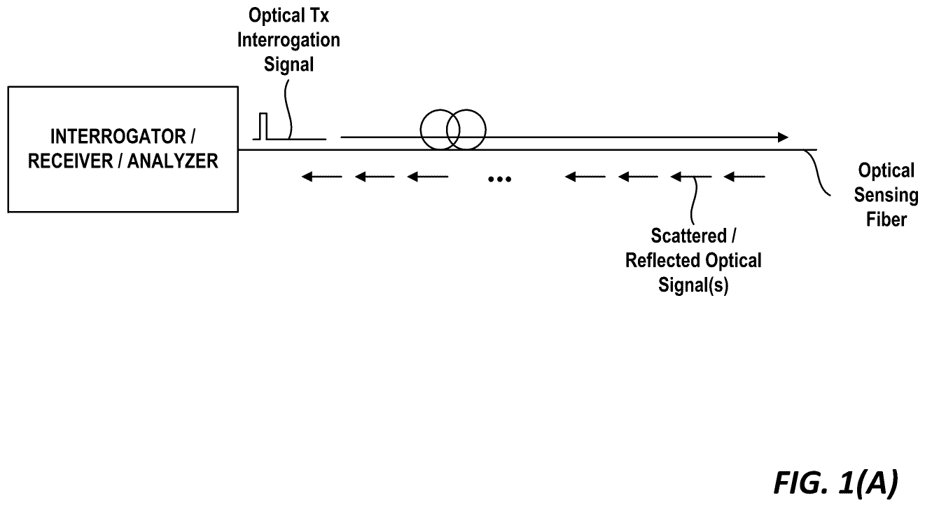

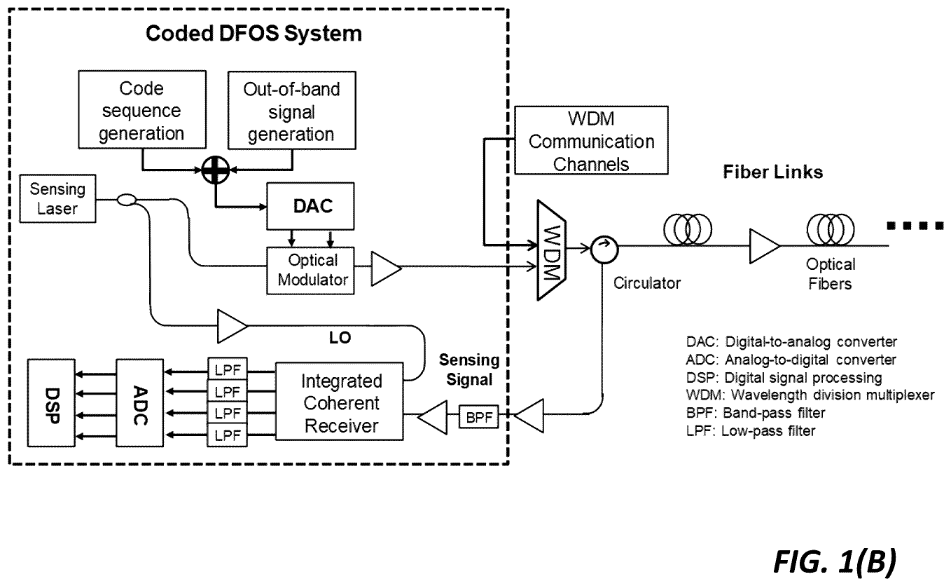

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

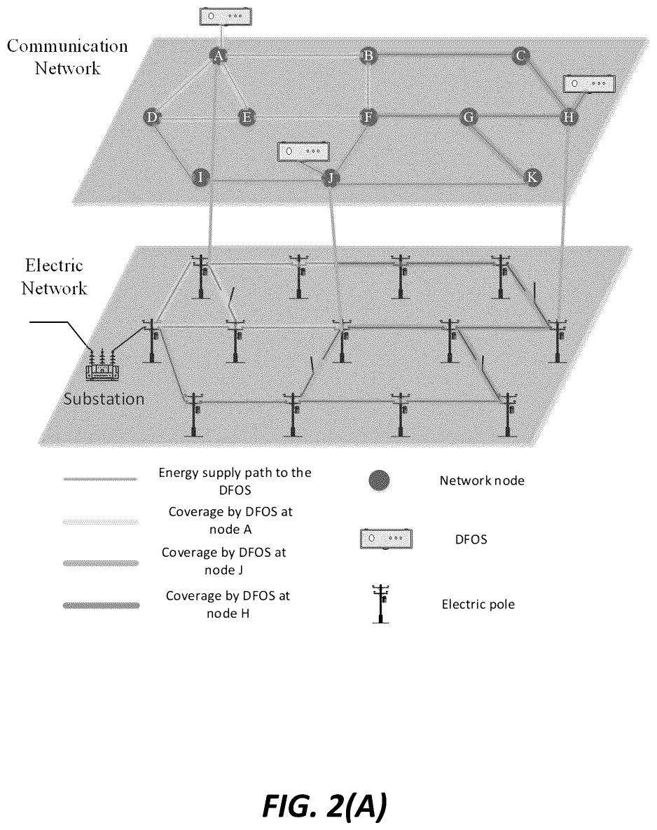

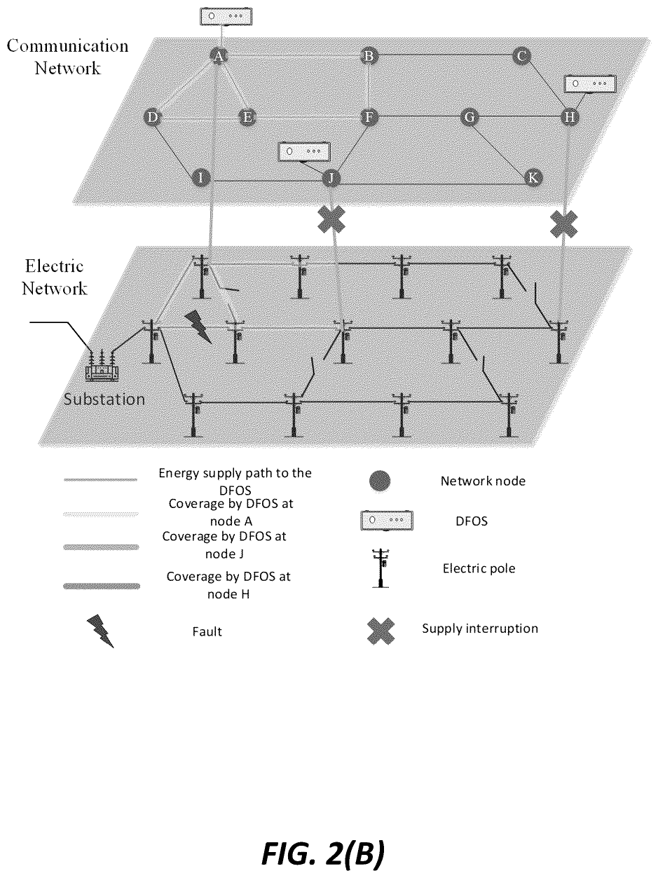

FIG. 2(A) and FIG. 2(B) show example DAS placement strategy for monitoring an electric network in which: FIG. 2(A) shows full coverage during normal conditions; and FIG. 2(B) shows reduced coverage during failure conditions according to aspects of the present disclosure. The illustration shows how, under normal conditions, these devices can effectively monitor the entire system. However, it highlights the vulnerabilities that arise when power supply failures occur, rendering large portions of the network unobservable.

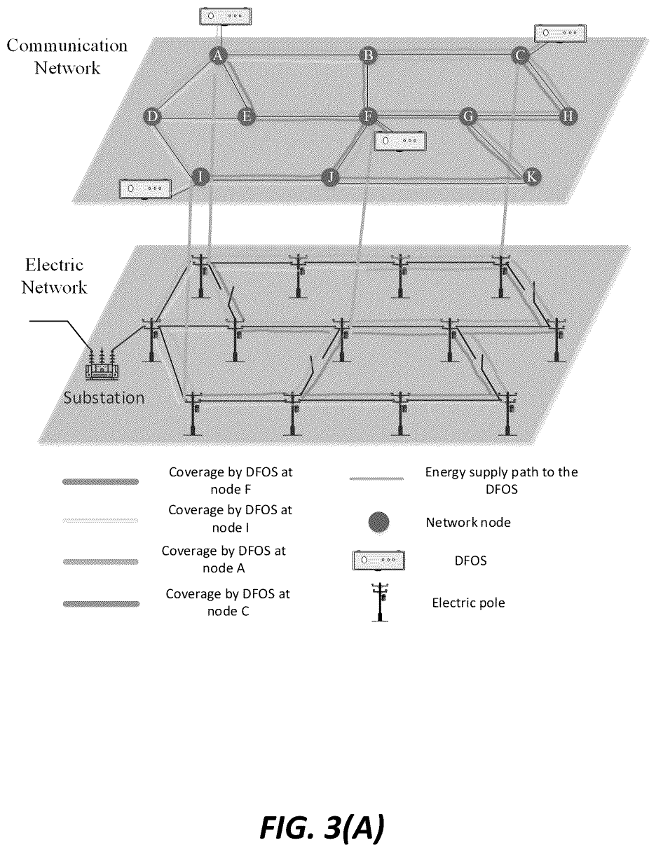

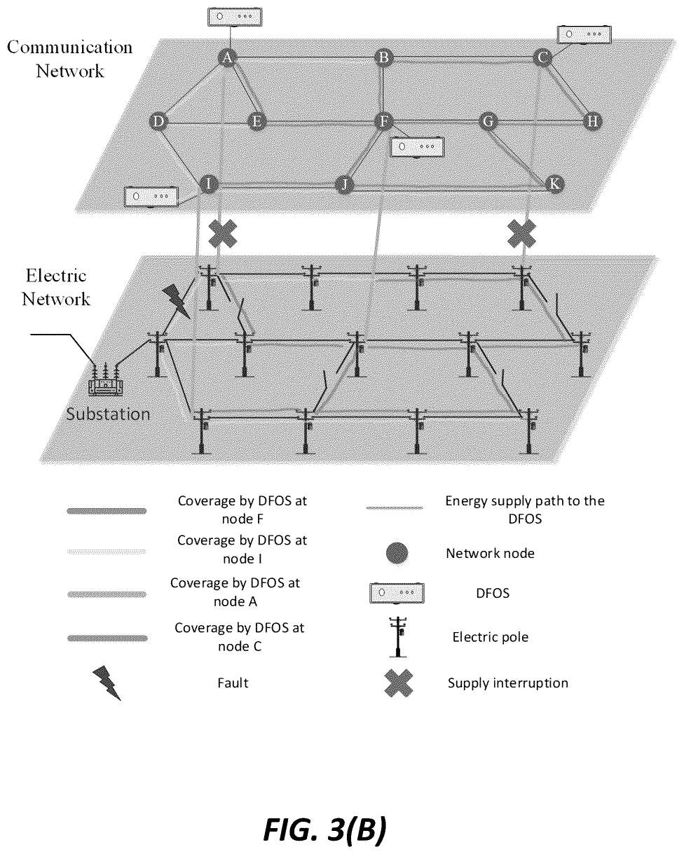

FIG. 3(A) and FIG. 3(B) show example DAS placement strategy for resilient system monitoring for an electric network in which: FIG. 3(A) shows full coverage during normal conditions; and FIG. 2(B) shows continuous coverage during DAS device failure conditions according to aspects of the present disclosure.

With reference to FIG. 3(A) and FIG. 3(B), we outline how our inventive method provides the following solutions.

### Redundant Monitoring:

For illustration purpose, four DAS devices are strategically installed to cover the entire monitoring area, as depicted in FIG. 3(A). Each line or node within the system is monitored by at least two DAS devices. This redundancy ensures that if one DAS device fails, the system remains fully monitored by the remaining devices.

### Power Supply Vulnerability:

A critical issue arises when multiple DAS devices are powered by the same electric feeder. If a fault occurs in that feeder, it could simultaneously disable all connected DAS devices. This vulnerability is highlighted in FIG. 2(B), where a fault in the upper feeder section causes the DAS devices at nodes A and C to stop functioning.

### Power Supply Criterion:

To mitigate this risk, the proposed solution introduces a “power supply criterion” that must be followed during DAS placement. According to this criterion, if two or more DAS devices are powered by the same feeder or zone, their monitoring coverage areas must be disjointed. This ensures that even if a single feeder fault disables multiple DAS devices, the remaining active devices continue to provide full system coverage.

### Resilient Coverage Under Fault Conditions:

As illustrated in FIG. 2(B), despite the failure of the DAS devices at nodes A and C due to a power supply fault, the remaining two active DAS devices continue to monitor the entire system effectively. This is achieved by ensuring that the coverage areas of the DAS devices are disjointed, allowing the system to maintain complete monitoring despite localized failures . . . .

As we shall show and describe, our inventive method enhances the resilience of the monitoring system by ensuring that even in the event of DAS device failures, whether caused by power outages or malfunctions, the system remains fully monitored. By strategically deploying DAS devices according to the “power supply criterion,” the solution effectively mitigates the risk of complete monitoring failure due to feeder faults, thereby ensuring continuous and reliable system surveillance

As those skilled in the art will understand and appreciate, inventive features of our method according to aspects of the present disclosure for resilient DAS placement contribute significantly to solving the challenges associated with ensuring continuous and reliable monitoring of critical infrastructure, particularly under power supply constraints. These features include at least the following.

Optimized DFOS Placement with Redundance

Feature: The algorithm ensures that each utility asset is monitored by at least two DAS devices.

Contribution: This redundancy ensures that even if one DAS device fails, the system remains fully monitored, addressing the critical need for resilient infrastructure monitoring.

### Integration of Electric and Communication Network Topologies

Feature: The algorithm integrates the topologies of both the electric and communication networks to determine the optimal placement of DFOS devices.

Contribution: By leveraging the overlapping areas of these networks, the algorithm ensures that the monitoring system is robust, utilizing the existing infrastructure to enhance coverage and minimizes deployment costs.

### Power Supply Criterion for DAS Placement

Feature: The algorithm introduces a “power supply criterion” that requires DFOS devices powered by the same feeder or zone to have disjoint monitoring routes.

Contribution: This criterion mitigates the risk of simultaneous DFOS failures due to power supply issues, ensuring that the system remains operational even during localized power outages.

### Heuristic Optimization Approach

Feature: A heuristic algorithm is employed to solve the NP-hard problem of DAS placement, utilizing Integer Linear Programming (ILP) combined with strategic adjustments to coverage routes.

Contribution: This approach enables the solution to be computationally feasible and practical for large-scale real-world applications, balancing the need for optimal coverage with the constraints of power supply and network topology.

### Disjoint Threshold for Coverage Paths

Feature: The algorithm incorporates a disjoint threshold, allowing for partial overlap of coverage paths when complete disjointedness is challenging to achieve.

Contribution: This flexibility ensures that the algorithm can be applied to complex networks where perfect disjointness is not feasible, providing a practical solution that still maintains high resilience.

### Re-Optimization Capability

Feature: The algorithm includes a re-optimization process that adjusts DAS locations and coverage routes if the initial solution does not meet the disjoint threshold.

Contribution: This iterative process ensures that the final solution is robust and meets the resilience criteria, further enhancing the reliability of the monitoring system.

### Application to Real-World Networks

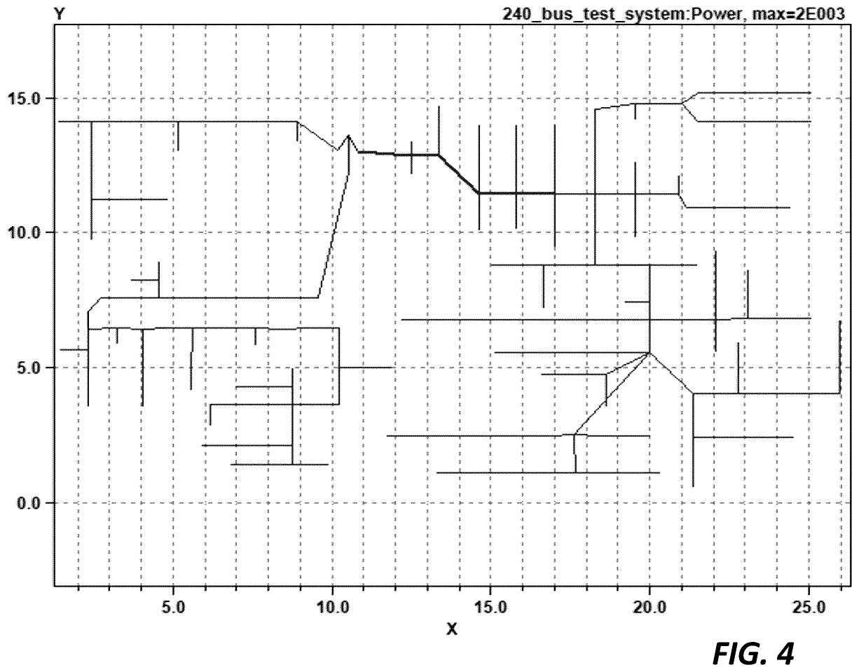

Feature: The algorithm is designed to be implemented and validated on real-world power distribution and communication networks, as demonstrated in the case study involving a network in the Midwest U.S as presented in FIG. 4, which shows a real-world 240 node distribution network located in Midwest U.S. according to aspects of the present invention.

Contribution: The real-world applicability of the solution ensures that it is not just theoretically sound but also practically viable, making it a valuable tool for utility companies and infrastructure managers.

These inventive features collectively address the key challenges associated with resilient monitoring of critical infrastructure using DFOS technology. By optimizing the placement of DAS devices, ensuring redundancy, and considering power supply constraints, the proposed solution significantly enhances the reliability and efficiency of infrastructure monitoring systems.

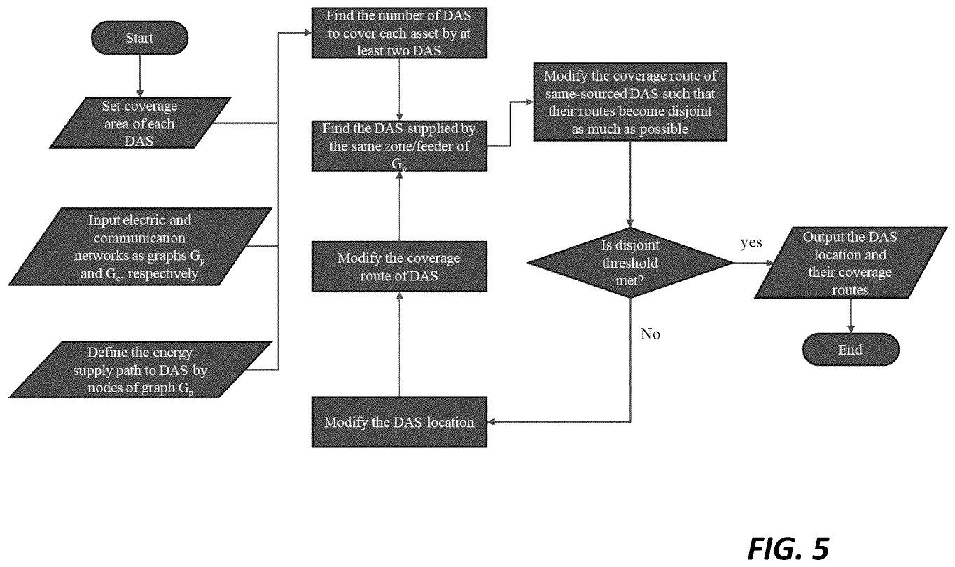

FIG. 5 shows a flow-chart of an illustrative heuristic method for finding DAS location and coverage routes according to aspects of the present disclosure.

Here is a detailed step-by-step description of the process:

### Step 1: Input Data Collection

Gather all necessary input data for the placement and coverage planning of DAS devices.

Collect information about the coverage area and range of each DFOS device (e.g., DAS).

Obtain the topologies of the electric distribution network and the communication network, represented as graphs.

Identify the energy supply paths to each potential DAS location within the electric network.

### Step 2: Formulation of the Objective Function

Define the objective function to minimize the total number of DAS devices required for resilient monitoring.

For a given set of DAS D, we want to minimize the total number of DAS devices:

$$min {\sum }_{d ∈ D} {x}_{d}$$

where x_{d}∈{0,1} is binary variable indicating whether DAS d ∈ D is used (1) or not (0).

### Step 3: Applying Coverage Constraints

Ensure that every critical asset within the network is monitored by at least two DAS devices. We apply the coverage constraints for both nodes and edges in the network:

Each asset (both nodes v∈Vₚ and edges e∈Eₚ) must be covered by at least two DAS devices:

$${\sum }_{d ∈ D} {1}_{\{ v ∈ C ( d ) \}} \cdot {x}_{d} \geq 2 , ∀ v ∈ {V}_{p} ,$$

$${\sum }_{d ∈ D} {1}_{\{ e ∈ C ( d ) \}} \cdot {x}_{d} \geq 2 , ∀ e ∈ {E}_{p} ,$$

where 1_{{v∈C(d)}} and 1_{{e∈C(d)}} are indicator functions that are 1 if v or e is within the coverage of DAS d, respectively and C(d) is the coverage area of DAS d∈D.

### Step 4: Identify Power Supply Dependencies

Determine which DAS devices are powered by the same feeder or zone within the electric distribution network.

Analyze the energy supply paths to each DAS device.

Identify pairs of DAS devices (d, d′) that are powered by the same zone or feeder.

### Step 5: Apply the Disjoint Coverage Constraint

Modify the coverage routes of DAS devices that share the same power source to ensure their routes are disjointed, reducing the risk of simultaneous monitoring failure.

$$Disjoint ( d , {d}^{′} ) = 1 , ∀ d , {d}^{′} ∈ D such that {Z}_{d} = {Z}_{{d}^{′}}$$

where Z_{d} is the zone or feeder supplying power to DAS d.

### Step 6: Evaluate Disjoint Coverage Threshold

Assess whether the adjusted coverage routes meet a pre-defined disjoint threshold, ensuring that the system remains resilient even if one or more DAS devices fail.

Calculate the level of overlap between the coverage routes of DAS devices powered by the same source.

Compare this overlap against the disjoint threshold. If the threshold is not met, proceed to Step 7 for re-optimization.

### Step 7: Re-Optimize DFOS Locations and Routes (if Necessary)

Objective: Re-adjust DAS placement and coverage routes if the initial configuration does not meet the disjoint threshold.

### Actions:

Re-solve the ILP problem with modified constraints to achieve a more resilient placement of DAS devices.

Iterate on the adjustment of coverage routes and DAS locations until the disjoint threshold is satisfied.

### Step 8: Finalize DFOS Placement and Coverage Routes

Confirm the final locations and coverage routes of all DAS devices, ensuring resilient system monitoring.

Output the finalized DAS locations and their corresponding coverage routes.

Document the final configuration, ensuring that all critical infrastructure assets are redundantly monitored and that the system can withstand single-point power failures.

### Step 9: Implementation and Validation

Validate the proposed DAS placement strategy on a real-world power distribution network.

Apply the finalized DAS placement strategy to a real-world network, such as the three-feeder, 240-node system in the Midwest U.S.

Validate the effectiveness of the placement strategy using simulation or real-world monitoring data.

Adjust the strategy as necessary based on the results of the validation phase.

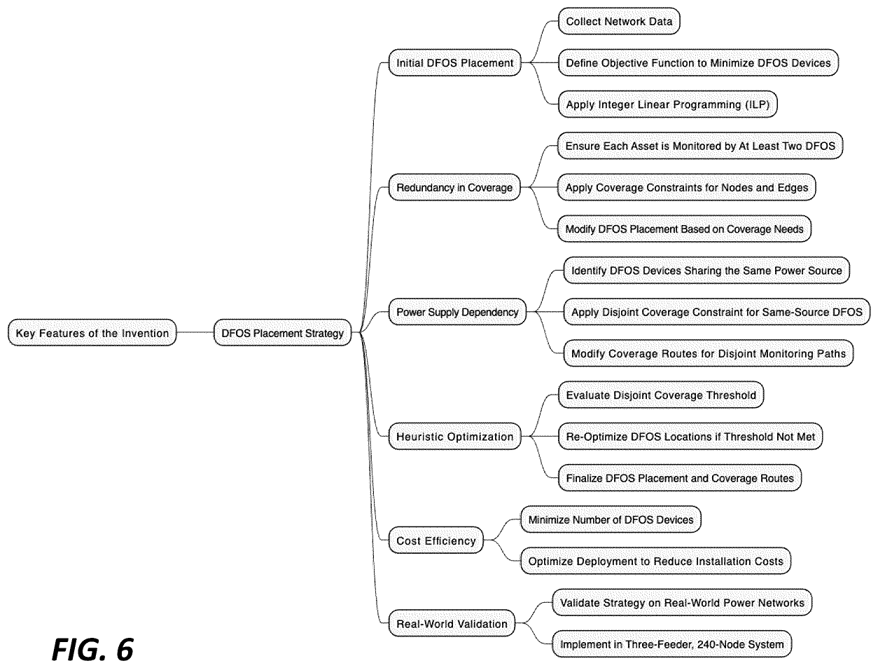

FIG. 6 shows an illustrative feature diagram in a hierarchical format according to aspects of the present invention.

We now describe case studies illustrating an operation of our inventive DFOS placement strategy that explicitly incorporates power supply constraints to enable resilient monitoring of critical infrastructure during power interruptions outages. By leveraging DFOS's remote sensing capacity, our method maximizes coverage while minimizing the risk of unmonitored zones due to power failures.

Our method advantageously combines a heuristic algorithm, PURE (Power Source-aware Route Exploration), with Integer Linear Programming (ILP) optimization. The PURE algorithm explores all possible fiber routes that satisfy both fiber-side constraints-such as linear, non-branching routes within the operational range and power-side constraints, ensuring that DFOS devices are powered independently. The ILP then selects the optimal set of DFOS units to minimize the total number of sensors while meeting monitoring requirements.

We demonstrate the versatility of our approach by applying it to two different network topologies: an IEEE standard radial topology for power distribution systems and a real-world mesh topology representative of telecommunication networks. These case studies highlight the broad applicability of our method and its ability to maintain resilient monitoring across diverse infrastructure types

Our case study optimizes the placement of DFOS units within a network to achieve resilient monitoring while minimizing the overall deployment cost. This involves determining the optimal DFOS locations and their corresponding fiber sensing routes under key constraints: (I) Fiber-side Constraints: Routes must be linear and nonbranching, with each DFOS route constrained by a maximum sensing range R; (2) Power-side Constraints: DFOS routes powered by the same feeder must remain disjoint to ensure maximum coverage during outages; (3) Critical Infrastructure Constraints: The system must prioritize monitoring of critical fiber links to maintain resilience.

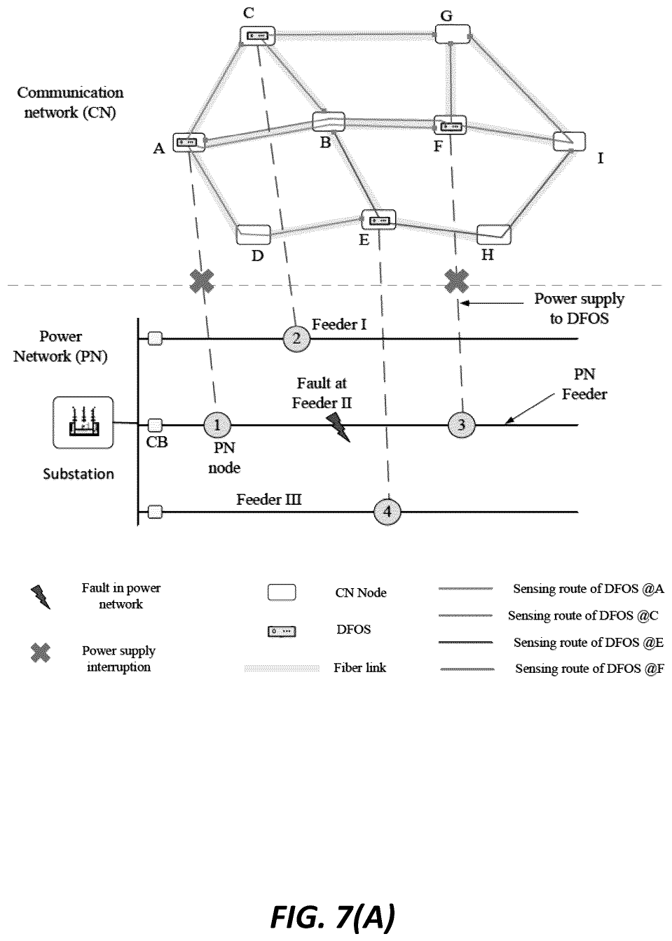

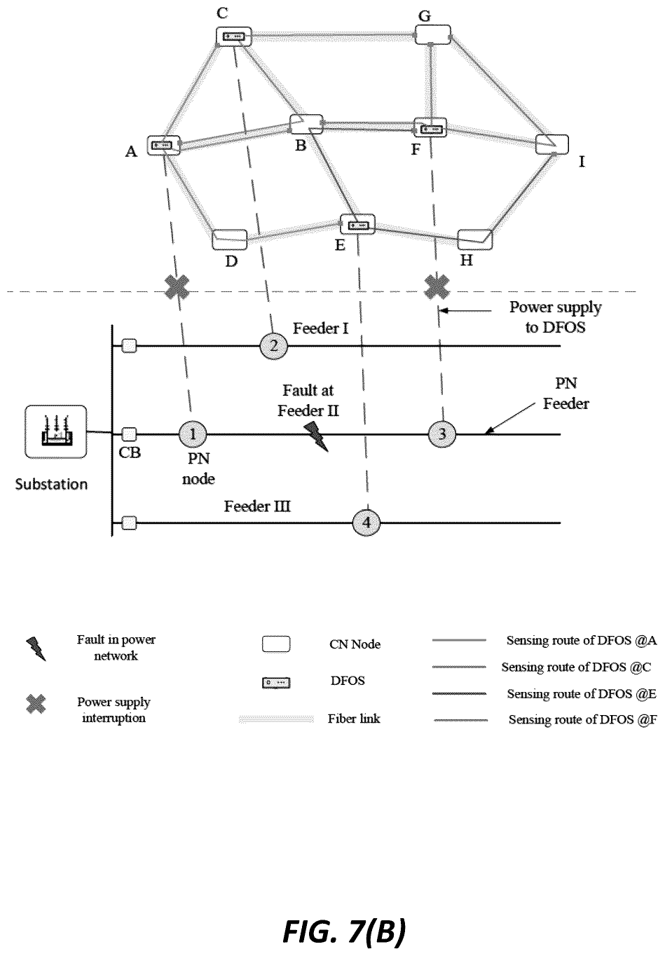

FIG. 7(A) and FIG. 7(B) show DFOS sensing routes in which: FIG. 7(A) is a power source unaware DFOS sensing route; and FIG. 7(B) is a power source aware DFOS sensing route according to aspects of the present disclosure.

FIG. 7(A) and FIG. 7(B) provide an example illustrating the impact of power supply failure on DFOS placement and monitoring. Initially, four DFOS devices are placed at nodes A, C, E, and F in the communication network, each powered by the nearest feeder in the electric network. Under normal operating conditions, as shown in FIG. 7(A), the DFOS units effectively monitor all critical infrastructures. However, if a fault occurs at Feeder 11, any DFOS devices powered by it (nodes A and F) would go offline during a prolonged outage, an Uninterruptible Power Supplies (UPS), if available, provide only limited backup power. This leads to a loss of monitoring for parts of the network, particularly the predetermined critical fiber link ABF, which requires redundant monitoring. Since both DFOS devices monitoring ABF depend on the Feeder II, their simultaneous failure leaves the critical link going unmonitored.

To address this issue, an optimized configuration is shown in FIG. 7(B), where the DFOS devices at nodes A and C monitor fiber link AB, and those at nodes E and F monitors fiber link BF. In this setup, even if Feeder II fails DFOS devices at nodes A and F go offline, the critical fiber link ABF remains monitored by the active DFOS devices at nodes C and E, which are powered by different feeders. This configuration ensures resilient monitoring of critical infrastructure despite feeder failures, highlighting the importance of incorporating power constraints into DFOS placement strategies.

The DFOS placement and sensing route optimization were implemented using a combined PURE algorithm and ILP approach. The proposed technique was applied to the fiber communication network (CN) integrated with a power network (PN) to determine the optimal DFOS locations and their associated sensing routes. The methodology was structured into two stages: (1) route exploration using the heuristic algorithm PURE, and (2) selection of the optimal DFOS locations via ILP optimization. As illustrated in FIG. 2(a), the process begins with the PURE algorithm, which considers the dependency relations of the DFOS on both the power network and the importance of fiber links. This algorithm generates all possible routes for each DFOS node while ensuring compliance with fiber-side and power-side constraints. Once all possible routes are identified, the ILP module selects the optimal DFOS placements with the consideration of a connectivity matrix C and monitored infrastructure-side constraints. The final output of the ILP optimization provides the optimal DFOS nodes and their corresponding sensing routes

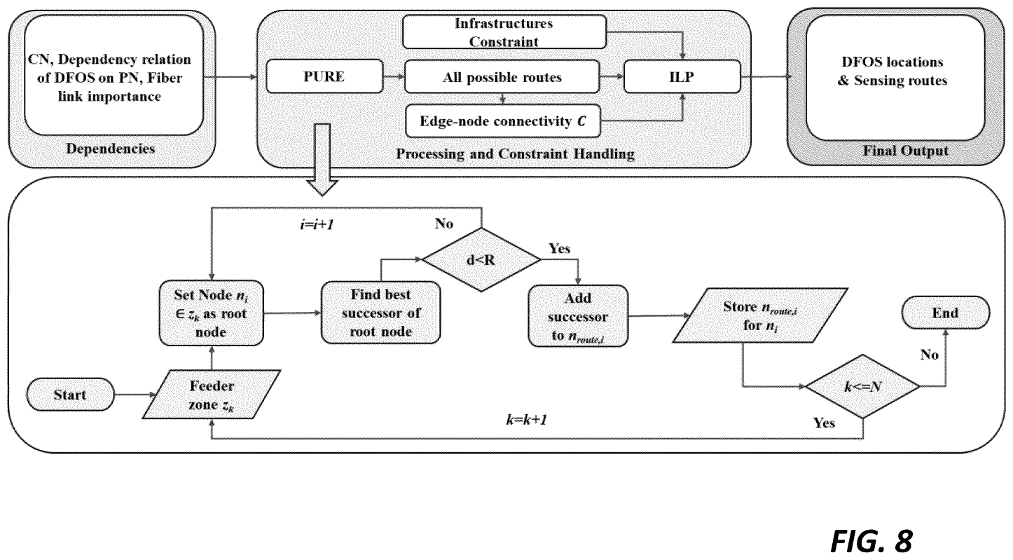

FIG. 8 is a schematic block diagram showing illustrative methodology according to the present disclosure and a breakout of the PURE algorithm employed according to aspects of the present disclosure.

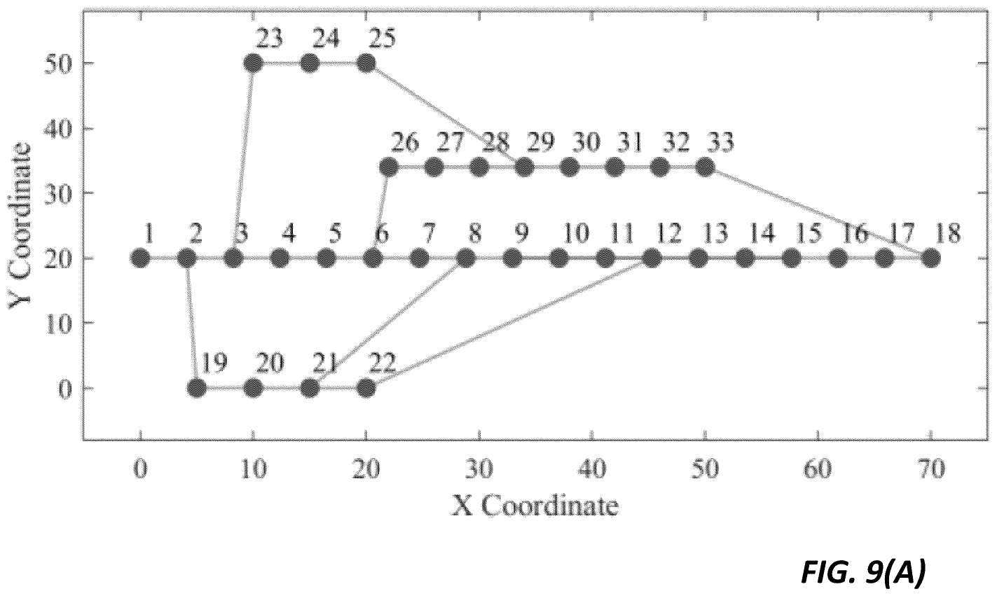

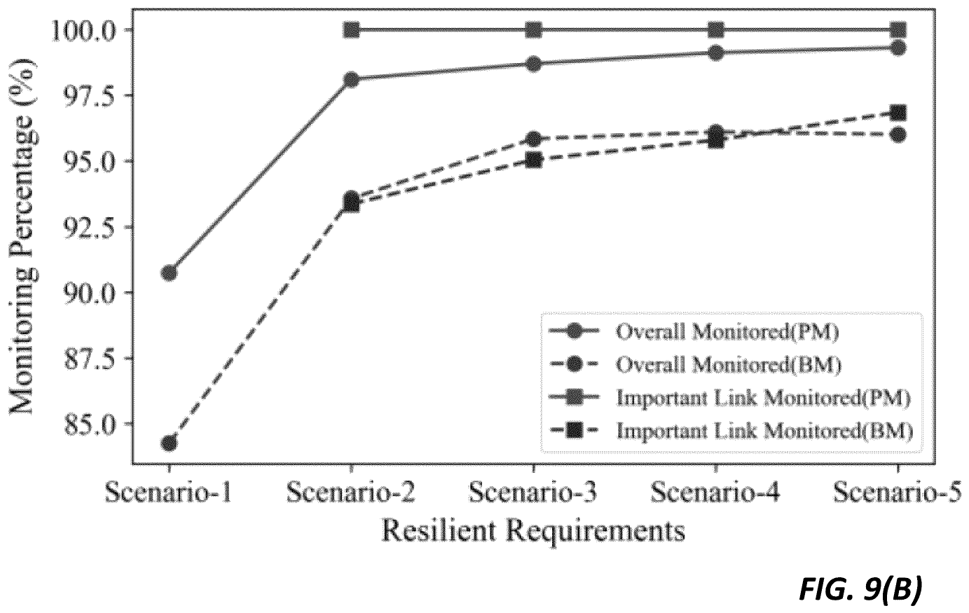

FIG. 9(A) and FIG. 9(B) show power infrastructure monitoring in which: FIG. 9(A) shows a network used for experiment: IEEE standard 33-node network; and FIG. 9(B) coverage comparison between proposed (PM) and baseline (BM) methods during a feeder zone outage, averaged over 100 runs; according to aspects of the present disclosure.

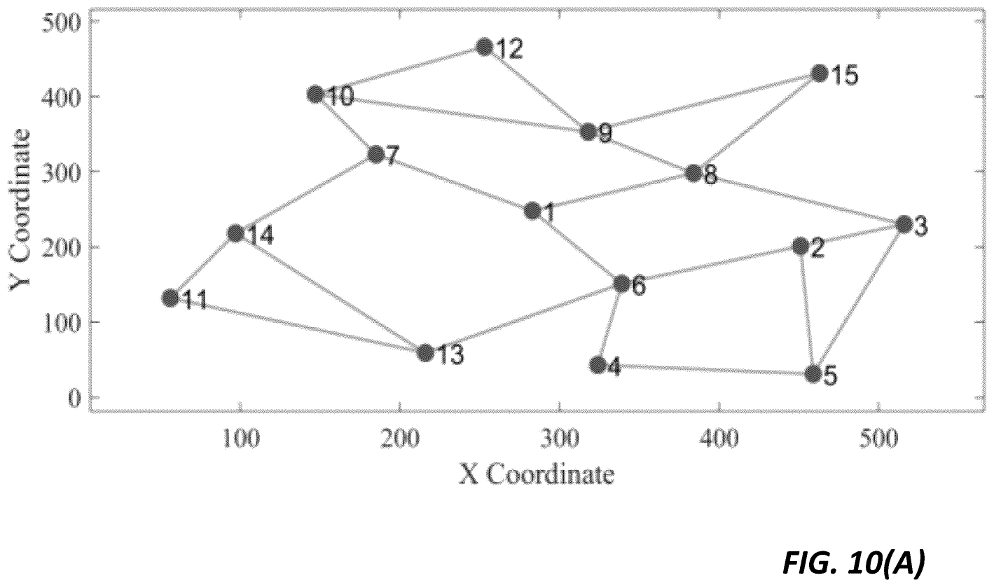

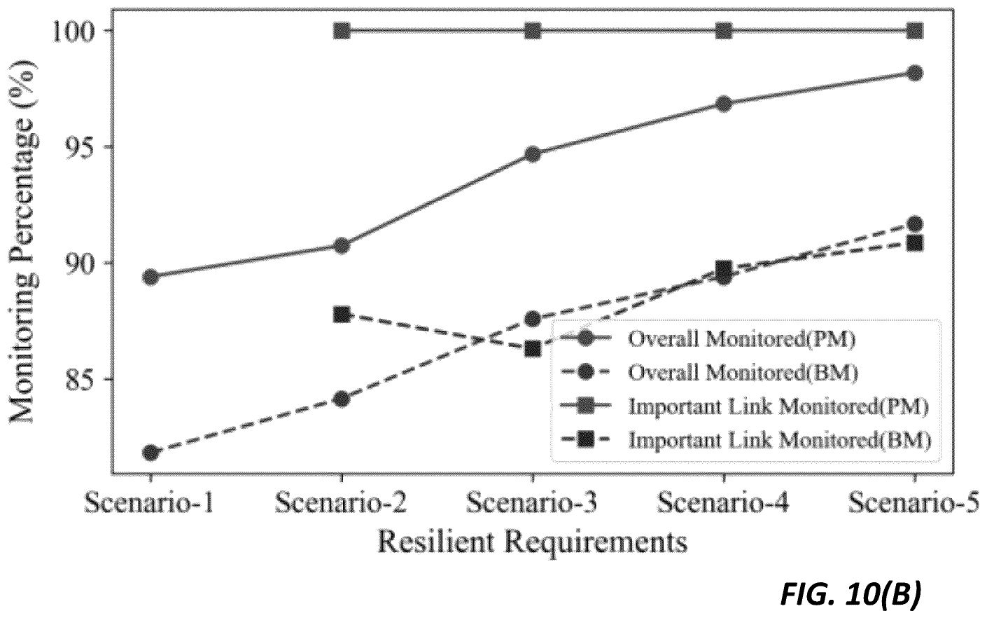

FIG. 10(A) and FIG. 10(B) show telecommunications network monitoring monitoring in which: FIG. 10(A) shows a network used for experiment: a real network in Atlanta, GA; and FIG. 10(B) coverage comparison between proposed (PM) and baseline (BM) methods durin a feeder zone outage, averaged over 100 runs; according to aspects of the present disclosure.

The pseudo-code for the PURE algorithm is presented in FIG. 8. The algorithm sorts the nodes based on their importance and iteratively explores possible fiber routes for each node being a potential DFOS location while adhering to both fiber and power constraints. At the end of each iteration, the obtained potential DFOS routes are stored for evaluation by the ILP. After identifying the possible routes, edge-node connectivity matrix C is obtained, which is a matrix of shape #edge-by-#node, with an element (j, i)=1 if an edge j is monitored by potential DFOS at node i, otherwise 0. Then the ILP module is employed, where the objective in ILP formulation is to minimize the total number ofDFOS deployed (i.e., Xi, where Xi is a binary variable indicating where a DFOS is placed at node i) and the constraints are to monitor all fiber links based on their required monitoring coverage, e.g., 2 for critical links and I for non-critical links (i.e., Cx>r, where x is the vector of Xi and r is the vector of monitoring requirements of links). This ensures that the most critical fiber links receive sufficient monitoring, even under power network failures.

### Case Study Results

Five resilient monitoring scenarios are presented to demonstrate the effectiveness of the proposed method (PM). In Scenario 1, there are no redundant link monitoring requirements, meaning all links are equally important and monitored by a single DFOS. However, from Scenario 2 to Scenario 5, a certain percentage of links—20%, 40%, 60%, and 80%, respectively—are considered more critical and require monitoring by two DFOS units for redundancy. A baseline model (BM) is developed for comparison, following the same procedure as the proposed method but without considering the power supply constraints for DFOS and using a greedy exploration strategy.

FIG. 9(A) and FIG. 9(B) show power infrastructure monitoring in which: FIG. 9(A) shows a network used for the case study experiment: IEEE standard 33-node network; and FIG. 9(B) coverage comparison between proposed (PM) and baseline (BM) methods during a feeder zone outage, averaged over 100 runs; according to aspects of the present disclosure.

FIG. 10(A) and FIG. 10(B) show telecommunications network monitoring in which: FIG. 10(A) shows a network used for experiment: a real network in Atlanta, GA; and FIG. 10(B) coverage comparison between proposed (PM) and baseline (BM) methods durin a feeder zone outage, averaged over 100 runs; according to aspects of the present disclosure.

For power network infrastructure monitoring, the power network topology, as given in FIG. 9(A), is selected from IEEE standard test systems, while the fiber communication network topology is assumed to be the same as the power network topology. This is a valid assumption, as power utilities often deploy fiber networks alongside power lines, resulting in a similar topology. In the power network monitoring, PM consistently outperforms BM in terms of overall monitoring coverage across all scenarios, while using the same DFOS budget, as shown in FIG. 10(A) and FIG. 10(B). More importantly, the proposed placement method ensures 100% observability of important fiber links during power outages affecting an electric feeder, due to its awareness ofDFOS power supply dependencies, as seen in FIG. 9(B).

Experiments are also conducted to demonstrate the superiority of the proposed method in telecommunication network monitoring. In this case, the telecommunication network is modeled based on a real network in Atlanta, GA, USA, as shown in FIG. 10(A). As the power network topology for the area is not publicly available, we designed a power utility network supplying power to the telecommunication network nodes, following standard practices in the power domain. The proposed method shows superior performance compared to the baseline in both overall network monitoring and important link monitoring, while maintaining similar DFOS budget as the baseline, as shown in FIG. 10(B). These experiments, conducted on two different critical infrastructure systems, establish the effectiveness of the proposed DFOS placement strategy.

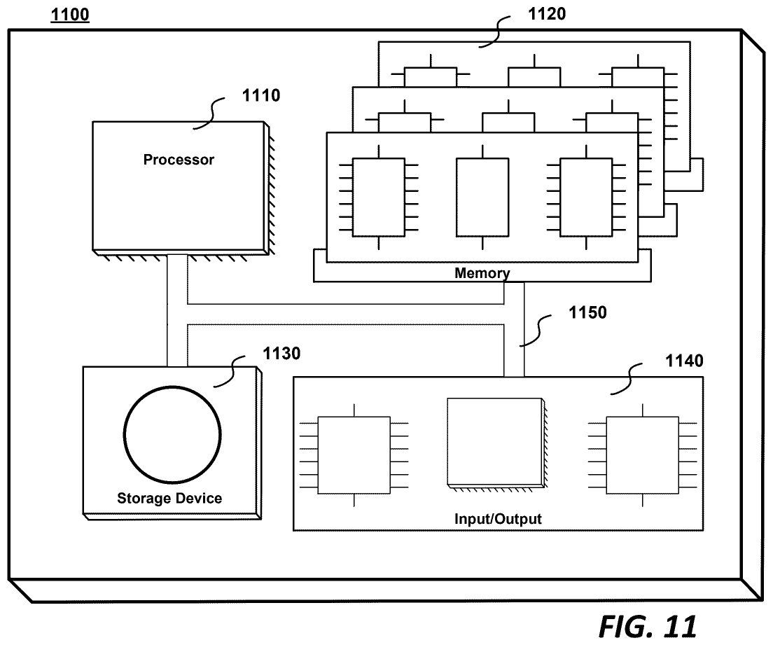

FIG. 11 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1100 as stored program control instructions.

Computer system 1100 includes processor 1110, memory 1120, storage device 1130, and input/output structure 1140. One or more input/output devices may include a display 1145. One or more busses 1150 typically interconnect the components, 1110, 1120, 1130, and 1140. Processor 1110 may be a single or multi core. Additionally, the system may include accelerators etc., further comprising the system on a chip.

Processor 1110 executes instructions in which embodiments of the present disclosure may comprise steps described in one or more of the Drawing figures. Such instructions may be stored in memory 1120 or storage device 1130. Data and/or information may be received and output using one or more input/output devices.

Memory 1120 may store data and may be a computer-readable medium, such as volatile or non-volatile memory. Storage device 1130 may provide storage for system 1100 including for example, the previously described methods. In various aspects, storage device 1130 may be a flash memory device, a disk drive, an optical disk device, or a tape device employing magnetic, optical, or other recording technologies.

Input/output structures 1140 may provide input/output operations for system 1100.

We now describe case studies illustrating an operation of our inventive DFOS placement strategy that explicitly incorporates power supply constraints to enable resilient monitoring of critical infrastructure during power interruptions outages. By leveraging DFOS's remote sensing capacity, our method maximizes coverage while minimizing the risk of unmonitored zones due to power failures.

Our method advantageously combines a heuristic algorithm, PURE (Power Source-aware Route Exploration), with Integer Linear Programming (ILP) optimization. The PURE algorithm explores all possible fiber routes that satisfy both fiber-side constraints-such as linear, non-branching routes within the operational range and power-side constraints, ensuring that DFOS devices are powered independently. The ILP then selects the optimal set of DFOS units to minimize the total number of sensors while meeting monitoring requirements.

We demonstrate the versatility of our approach by applying it to two different network topologies: an IEEE standard radial topology for power distribution systems and a real-world mesh topology representative of telecommunication networks. These case studies highlight the broad applicability of our method and its ability to maintain resilient monitoring across diverse infrastructure types

Our case study optimizes the placement of DFOS units within a network to achieve resilient monitoring while minimizing the overall deployment cost. This involves determining the optimal DFOS locations and their corresponding fiber sensing routes under key constraints: (1) Fiber-side Constraints: Routes must be linear and nonbranching, with each DFOS route constrained by a maximum sensing range R; (2) Power-side Constraints: DFOS routes powered by the same feeder must remain disjoint to ensure maximum coverage during outages; (3) Critical Infrastructure Constraints: The system must prioritize monitoring of critical fiber links to maintain resilience.

While we have presented our inventive concepts and description using specific examples, our invention is not so limited. Accordingly, the scope of our invention should be considered in view of the following claims.

1. A computer implemented method of power-aware distributed fiber optic sensor (DFOS) placement strategy for resilient infrastructure monitoring, the method comprising:
collecting input data including topologies of an electric distribution network and a communications network, coverage area and range for a plurality of DFOS devices and energy supply paths to potential DFOS device locations within the electric distribution network;
defining an objective function to minimize a total number of DFOS devices required for monitoring;
applying coverage constraints such that each critical asset within the networks is monitored by at least two DFOS devices;
applying a disjoint coverage constraint to modify coverage routes of the identified DFOS devices such that routes are disjoint;
outputting finalized DFOS device locations and their coverage routes.

2. The method of claim 1 further comprising evaluating whether the modified coverage routes meet a predefined disjoint threshold.

3. The method of claim 1 further comprising re-optimizing DFOS device locations and coverage routes if the disjoint threshold is not met.

4. The method of claim 3 wherein the topologies of the electric distribution network and the communication network are represented as graphs.

5. The method of claim 4 wherein the coverage constraints are applied to both nodes and edges in the networks.

6. The method of claim 1, wherein the objective function is represented formula:
$$min {\sum }_{d ∈ D} {x}_{d}$$
where x_{d} is a binary variable indicating whether DFOS device d is used.

7. The method of claim 1, wherein the re-optimizing step comprises re-solving an Integer Linear Programming (ILP) problem with modified constraints.

8. The method of claim 1, further comprising employing a heuristic algorithm, PURE (Power Source-aware Route Exploration), in combination with Integer Linear Programming (ILP) optimization, wherein the Pure algorithm explores all possible fiber routes that satisfy fiber-side constraints and power-side constraints.

9. The method of claim 8, wherein the power-side constraints require DFOS device routes powered by the same feeder to remain disjoint.

10. A system for resilient monitoring of critical infrastructure, the system configured to perform the method of claim 1.
